(19) United States
(12) Patent Application Publication
(10) Pub. No.: US 2011/0180108 A1
(43) Pub. Date: Jul. 28, 2011

(54) RETICLE CLEANING METHOD FOR A LITHOGRAPHY TOOL AND A RETICLE CLEANING SYSTEM THEREOF

(76) Inventors: Yung-Chin PAN, Tucheng City (TW); Hai-Ching Hsu, Tucheng City (TW)

(21) Appl. No.: 12/764,197

(22) Filed: Apr. 21, 2010

(30) Foreign Application Priority Data
Jan. 25, 2010 (TW) 099101877

(51) Int. Cl. B08B 7/00

(52) U.S. Cl. 134/21; 134/115 R

(57) ABSTRACT

A reticle cleaning method for a lithography tool, wherein an inspection apparatus deployed in the lithography tool is used to perform the cleaning procedure on reticle in the EUV reticle pod, the reticle cleaning method comprising: transporting the EUV reticle pod to the upper chamber of the inspection apparatus; forming vacuum in the upper chamber of the inspection apparatus; transporting the inner box of the EUV reticle pod to the lower chamber of the inspection apparatus; forming vacuum in the lower chamber of the inspection apparatus; performing the cleaning process multiple times for gas filling and vacuum exhausting, wherein an inert gas is provided for the process of gas filling to be performed multiple times on the inner box to allow the particles in the inner box to be brought away by the flow field formed by the inert gas in the inner box; and transporting the inner box to a reticle library.

### BACKGROUND OF THE INVENTION

1. Field of the Invention

The present field of the invention is related to a reticle cleaning method, and more particularly, to a reticle cleaning system for extreme ultraviolet (EUV) lithography tool and the reticle cleaning method thereof.

2. Description of the Prior Art

In the rapidly developing modern semiconductor technology, optical lithography tool plays an important role. The pattern definition relies fully on optical lithography technology. In the application of optical lithography tool related to semiconductors, pre-designed circuit paths are fabricated as light-transparent reticle in specific form. Basing on the principle of exposure, after light from the light source passes through the reticle and is projected on a silicon wafer, specific circuit pattern can be exposed on the silicon wafer. Since any kind of dust (such as particles, powders, and organic matters) adhering to the reticle can cause degradation of the quality of the projected pattern, the reticle used to produce pattern on silicon wafers is required to be kept absolutely clean. Therefore in ordinary wafer processes, clean rooms are provided for preventing from contamination caused by particles in the air. However, the status of absolute dustless is still inaccessible in clean rooms at present. In modern semiconductor processes, contamination-resistant reticle pods are thus employed for storing and transporting reticles to maintain the cleanliness of reticles.

Then, referring to FIG. 1, which is a schematic view of lithography tool as disclosed in U.S. Pat. No. 6,471,037. In lithography tool 6, a relative vacuum status is maintained. The whole operation of lithography tool 6, including the operation of a first inspection apparatus 52 for identifying reticles, observing reticles, measuring the thickness of reticles, and cleaning reticles, can be controlled by a controller; a reticle conveyance robot 4 can carry the reticle out of the inspection apparatus 52 and then place it in the reticle library 53 according to the command of the controller; then, according to the demands of processes, the reticle is carried out of the reticle library 53 by the robot, conveyed to a reticle pre-alignment station 54, and then carried to a projection optical system for the exposure process to be performed. Apparently, in the lithography tool 6 as shown in FIG. 1, the reticle only go through cleaning process for one time when being in the inspection apparatus 52 and is then conveyed to the reticle library 53 to wait for the exposure process to be performed.

In recent years, in order to produce smaller chips, lithography tool has started to use extreme ultraviolet light (EUV) with wavelength of 157 nm to achieve higher resolution when the pattern on the reticle is copied onto the surface of the wafer. However, when the EUV light is used, the standard of cleanliness of reticle pod is also correspondingly raised. Previously it is acceptable if the particles in the reticle pod are smaller than 30 μm, but in EUV reticle pod the diameter of dust or particles has to be controlled between 30 and 50 nm. Moreover, the optical lithography tool is also highly sensitive to dust or particles existing therein, such as airborne molecular contaminations (AMC) or sulfate or nitrate formed after the ozone oxidization of SO2 and NO2 and depositing on the surface of lens that will cause lens haze. Furthermore, due to the delicacy of pattern on EUV reticle, damages to the pattern caused by the discharge of static electricity also occur frequently, and thus prevention of ESD should be taken into consideration as well.

### SUMMARY OF THE INVENTION

Considering the above, the present invention provides an EUV reticle cleaning apparatus and the cleaning method thereof with the objective of enhancing the quality of exposure of lithography tool. The primary technology lies in the cleaning process in which vacuum exhausting and gas filling procedures are performed multiple times to remove particles and electric charges on the EUV reticle before the EUV reticle is conveyed to the reticle library; or the cleaning procedure is selectively performed on EUV reticle one more time before an EUV reticle is selected by the reticle library to enter the projection optical system for the exposure process to be performed to ensure the cleanliness of the EUV reticle and the best quality of the exposure process for increasing the product yield.

According to the aforementioned objective, the present invention first provides a reticle cleaning method for lithography tool, in which an inspection apparatus composed of an upper chamber and a lower chamber and deployed in the lithography tool performs cleaning procedure on reticle in an EUV reticle pod, wherein the reticle cleaning method comprises: transporting the EUV reticle pod to the upper chamber of inspection apparatus, the EUV reticle pod including an outer box and an inner box within which the reticle is stored; the upper chamber being formed in a vacuum status; transporting the inner box of the EUV reticle pod to the lower chamber of the inspection apparatus; then performing the cleaning procedure on the reticle by first vacuum exhausting the lower chamber and then filling the EUV reticle pod with gas, wherein an inert gas is provided for filling the inner box to form a gas flow field in the inner box that is able to bring away particles on the reticle; transporting the inner box to a reticle library.

The present invention then provides a reticle cleaning method for lithography tool, in which an inspection apparatus composed of an upper chamber and a lower chamber and deployed in the lithography tool performs cleaning procedure on reticle in an EUV reticle pod, wherein the reticle cleaning method comprises: transporting the EUV reticle pod to the upper chamber of inspection apparatus, the EUV reticle pod including an outer box and an inner box within which the reticle is stored; the upper chamber being formed in a vacuum status; transporting the inner box of the EUV reticle pod to the lower chamber of the inspection apparatus; performing the cleaning procedure on the reticle by first vacuum exhausting the lower chamber and then filling the EUV reticle pod with gas, wherein the gas filling procedure comprises: providing an ionized inert gas for filling the inner box, further providing an inert gas for filling the inner box after the filling of ionized inert gas is completed for the ionized inert gas to form a gas flow field in the inner box that is able to remove the electric charges on the reticle and simultaneously for the inert gas to form another gas flow field in the inner box that is able to bring away particles on the reticle; transporting the inner box to a reticle library.

The present invention further provides a reticle cleaning method for lithography tool, in which an inspection apparatus composed of an upper chamber and a lower chamber and deployed in the lithography tool performs cleaning procedure on reticle in an EUV reticle pod, wherein the reticle cleaning method comprises: transporting the EUV reticle pod to the upper chamber of inspection apparatus, the EUV reticle pod including an outer box and an inner box within which the reticle is stored; the upper chamber being formed in a vacuum status; transporting the inner box of the EUV reticle pod to the lower chamber of the inspection apparatus; then performing the cleaning procedure on the reticle by first vacuum exhausting the lower chamber and then filling the EUV reticle pod with gas, wherein an inert gas is provided for filling the inner box to form a gas flow field in the inner box that is able to bring away particles on the reticle; transporting the inner box to a reticle library; transporting the inner box to a second inspection apparatus to perform the gas filling procedure for at least once; transporting the inner box to an optical system for the exposure process to be performed.

The present invention further provides a reticle cleaning system deployed in lithography tool that performs the cleaning procedure on reticle in an EUV reticle pod as commanded by a controller in lithography tool, the EUV reticle pod comprising an outer box and an inner box within which the reticle is stored, wherein the reticle cleaning system comprises: an inspection apparatus composed of an upper chamber and a lower chamber isolated from each other, a base being disposed in the lower chamber and a vacuum exhausting valve and at least a gas valve being disposed on the base; and a robot disposed in a vacuum transportation chamber for performing transportation of inner box of EUV reticle pod.

The present invention further provides a reticle cleaning system deployed in lithography tool that performs the cleaning procedure on reticle in an EUV reticle pod as commanded by a controller in lithography tool, the EUV reticle pod comprising an outer box and an inner box within which the reticle is stored, wherein the reticle cleaning system comprises: a first inspection apparatus composed of an upper chamber and a lower chamber isolated from each other, a base being disposed in the lower chamber and a vacuum exhausting valve and at least a gas valve being disposed on the base; a robot disposed in a vacuum transportation chamber for performing transportation of inner box of EUV reticle pod; and a second inspection apparatus disposed with a nozzle.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic view of lithography tool of prior art;

FIG. 2 is a schematic view of lithography tool with reticle cleaning system of the present invention;

FIG. 3 is a sectional view of cleaning system of the present invention;

FIG. 4 is a perspective view of lower chamber of the present invention;

FIG. 5 is a schematic view of reticle cleaning system of the present invention;

FIG. 6 is a schematic view of another embodiment of reticle cleaning system of the present invention.

### DESCRIPTION OF THE PREFERRED EMBODIMENT

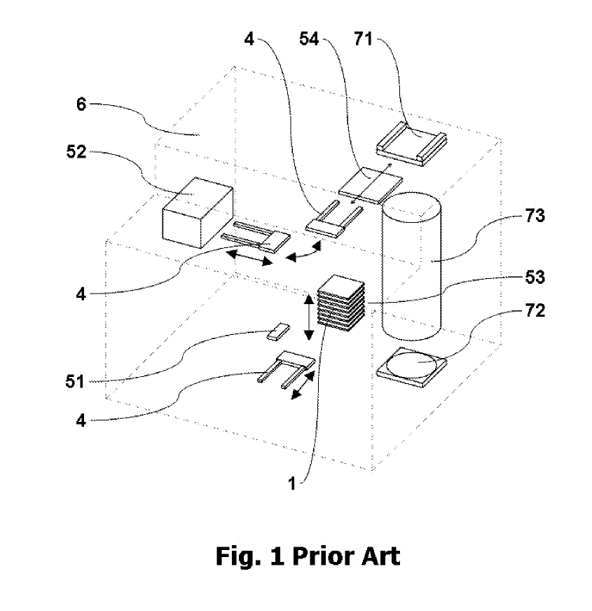

The present invention mainly discloses a reticle cleaning method for lithography tool and a reticle cleaning system in lithography tool corresponding to the reticle cleaning method. Therefore in the following description, not every component of conventional lithography tool or that of prior art is described in detail in order to limit the focus to the reticle cleaning method and reticle cleaning system of the present invention. The following description thus focuses on the parts related to the reticle cleaning method and reticle cleaning system of the present invention. More specifically, the lithography tool described in the present invention includes the lithography tool as disclosed in U.S. Pat. No. 6,471,037, as shown in FIG. 1. In order to disclose the technological contents employed by, objectives of, and effects achieved by the present invention in a more complete and clearer way, detailed description accompanied by figures and signs for reference is disclosed as below.

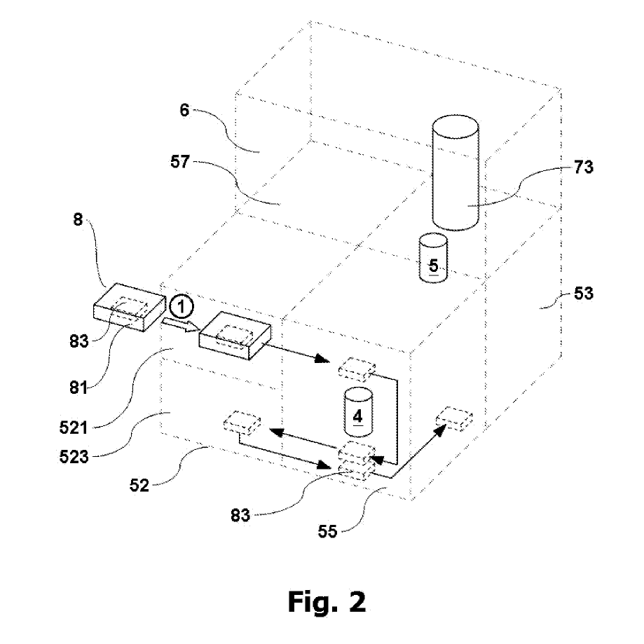

First, as shown in FIG. 2, which is a schematic view of lithography tool with reticle cleaning system of the present invention. A relative vacuum status (10⁻⁶ torr for example) is maintained in the interior of lithography tool 6 of the present invention, and the whole operation of lithography tool 6 can be controlled by a controller (not shown in Figure), wherein the lithography tool 6 comprises a first inspection apparatus 52, a reticle library 53, a transportation chamber 55 and a reticle pod conveyance robot 4 disposed in the transportation chamber 55, a second inspection apparatus 57, an optical system 73, and a robot 5 for transporting the reticle from the second inspection apparatus 57 to the optical system 73. The cleaning system in lithography tool 6 is composed of the first inspection apparatus 52, the transportation chamber 55, and the reticle pod conveyance robot 4 disposed in the transportation chamber 55, wherein the first inspection apparatus 52 of the present invention is further segregated into an upper chamber 521 and a lower chamber 523 for the EUV reticle pod 8 to be loaded in the upper chamber 521 and for the inner box 83 of the EUV reticle pod to be carried out and transported to the lower chamber 523 for the cleaning procedure to be performed. Moreover, what is to be further described is that, the apparatuses located in the interior of lithography tool 6 and in which a relative vacuum status (10⁻⁶ torr for example) needs to be maintained are reticle library 53, optical system 73, and robot 5; and the vacuum status in the apparatuses composing the cleaning system needs to be formed by different pump; the operation for forming vacuum status is described in detail in the following embodiments.

Referring then to FIG. 2, the primary objective of the reticle cleaning system of the present invention is to perform the cleaning procedure on EUV reticle pod 8. Therefore, when the carrier (not shown in Figure) in which a plurality of EUV reticle pods 8 is placed in the lithography tool 6, the controller in the lithography tool 6 commands the EUV reticle pods 8 in the EUV reticle pod carrier to be loaded in the lithography tool 6, as indicated by the direction shown by arrow No. 1 as manifested in FIG. 2. Then, the controller commands each EUV reticle pod 8 to be transported to the first inspection apparatus 52 in sequence for reticle identification, reticle observation, and reticle cleaning to be performed in the first inspection apparatus 52.

Then, referring to the FIG. 3, which is a sectional view of cleaning system of the present invention. When the EUV reticle pod 8 is transported to the first inspection apparatus 52, the controller breaks the vacuum in the first inspection apparatus 52 (i.e. releasing air) and opens the first side door (i.e. the outer side door) of the upper chamber 521 of first inspection apparatus 52 for the EUV reticle pod 8 to be transported into the upper chamber 521; then, the controller closes the outer side door of the upper chamber 521 and performs vacuum exhausting; when the degree of vacuum in the upper chamber 521 reaches 10⁻¹ torr, the controller opens the second side door (i.e. inner side door) of the upper chamber 521 (at this moment, the degree of vacuum in the transportation chamber 55 reaches 10⁻³ torr) for the reticle pod conveyance robot 4 (such as a tri-axis robot that is able to perform movement in different directions and at different heights) in the transportation chamber 55 to carry out the inner box 83 of the EUV reticle pod 8; the robot 4 then returns to the transportation chamber 55, as indicated by the direction shown by arrow No. 2 as manifested in FIG. 3. Then, the controller opens the inner side door of the lower chamber 523, the robot 4 transports the inner box 83 into the lower chamber 523 and places the inner box 83 on the base 525 in the lower chamber 523, and the robot 4 again returns to the transportation chamber 55, as indicated by the direction shown by arrow No. 3 as manifested in FIG. 3. At the same time, the controller commands the outer box 81 in the upper chamber 521 to be moved out of the first inspection apparatus 52 and another EUV reticle pod 8 to be loaded in.

And then, when the inner box 83 is placed on the base 525 in the lower chamber 523, the controller closes the inner side door of the lower chamber 523 and performs vacuum exhausting; when the degree of vacuum in the lower chamber 523 reaches 10⁻¹ torr, the cleaning procedure of gas filling and vacuum exhausting is then performed multiple times. The multiple times of cleaning procedure of gas filling and vacuum exhausting in the present invention can be performed in two ways. One way is to use inert gas in the multiple times of cleaning procedure of gas filling and vacuum exhausting to bring away the particles on the surface of the reticle by the circulating flow field; the other way is, in the multiple times of cleaning procedure of gas filling and vacuum exhausting, to first use ionized inert gas to remove the electric charges on the reticle for preventing ESD, and then use inert gas to bring away the particles on the surface of the reticle by the circulating flow field. The operating process is then described in detail in the following.

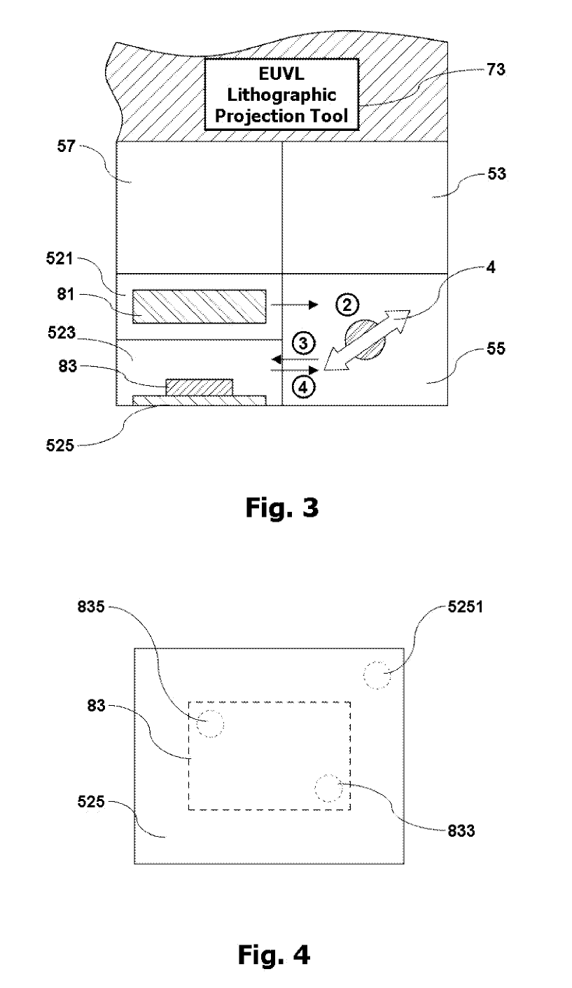

In the first embodiment of the present invention, when the inner box 83 is transported to the lower chamber 523, the inner box 83 is placed on the base 525 of the lower chamber 523 for the gas valves 833 and 835 on the base 525 to correspond with and contact the two gas valves (not shown in Figure) on the inner box 83, as shown in FIG. 4; then, the controller closes the inner side door of the lower chamber 523, commands the vacuum exhausting valve 5251 on the base 525 to perform vacuum exhausting, and then shuts off the vacuum exhausting valve 5251 when the degree of vacuum in the lower chamber 523 reaches 10⁻¹ torr to maintain the degree of vacuum in the lower chamber 523 at 10⁻¹ torr. And the controller then commands the gas valve 833 to fill the inner box 83 with an inert gas (N2 or He for example) for a predetermined quantity and a predetermined gas filling time period; the other gas valve 835 on the base 525 then exhausts the inert gas in the inner box 83 for the inert gas to form gas flow field in the inner box 83 that is able to bring away the particles on the reticle in the inner box 83 to ensure the cleanliness of the reticle.

In addition, in the second embodiment of the present invention, when the inner box 83 is transported to the lower chamber 523, the inner box 83 is placed on the base 525 of the lower chamber 523 for the gas valves 833 and 835 on the base 525 to correspond with and contact the two gas valves (not shown in Figure) on the inner box 83, as shown in FIG. 4; then, the controller closes the inner side door of the lower chamber 523, commands the vacuum exhausting valve 5251 on the base 525 to perform vacuum exhausting, and then shuts off the vacuum exhausting valve 5251 when the degree of vacuum in the lower chamber 523 reaches 10⁻¹ torr to maintain the degree of vacuum in the lower chamber 523 at 10⁻¹ torr. And the controller then commands the gas valve 833 to fill the inner box 83 with an ionized inert gas (ionized nitrogen gas produced by passing nitrogen gas through ion-generating apparatus for example) for a predetermined quantity and a predetermined gas filling time period; the other gas valve 835 on the base 525 then exhausts the ionized inert gas in the inner box 83 for the ionized inert gas to form gas flow field in the inner box 83 that is able to remove the electric charges on the reticle in the inner box 83. Then the controller switches the gas to be filled to an inert gas and commands the gas valve 833 on the base 525 of the lower chamber 523 to fill the inner box 83 with an inert gas; the other gas valve 835 on the base 525 then exhausts the inert gas in the inner box 83 for the inert gas to form flow field of inert gas that is able to bring away the particles on the reticle in the inner box 83 to ensure the cleanliness of the reticle.

When the operation in the first or the second embodiment is completed, the controller terminates the operation of gas filling and shuts off the gas valve 833 and the gas valve 835 on the base 525 of the lower chamber 523; the controller then commands again the vacuum exhausting valve 5251 on the base 525 of the lower chamber 523 to perform vacuum exhausting for the degree of vacuum in the lower chamber 523 to reach 10⁻¹ torr. The aforementioned cleaning procedure of gas filling and vacuum exhausting is then repeated multiple times to achieve the effect of cleaning the reticle; in the present embodiment, the cleaning procedure of gas filling and vacuum exhausting is repeated 3 to 7 times; and in a preferred embodiment, the cleaning procedure of gas filling and vacuum exhausting is performed 5 times.

When the cleaning procedure on the inner box 83 in the lower chamber 523 is completed, the controller opens the inner side door of the lower chamber 523 for the robot 4 to carry out the inner box 83 and return to the transportation chamber 55, as indicated by the direction shown by arrow No. 4 as manifested in FIG. 3. The inner side door of the lower chamber 523 is then closed. Then the controller opens the reticle library 53 for the robot 4 to transport the inner box 83 into the reticle library 53 for storage and further use, as indicated by the direction shown by arrow No. 5 as manifested in FIG. 5. In the embodiment of the present invention, the reticle library 53 is disposed in high vacuum status in the interior of lithography tool 6, and the degree of vacuum is maintained between 10⁻³ torr and 10⁻⁶ torr. Apparently, a cleaning system is utilized in the present invention for performing cleaning procedure on the inner box 83 of each EUV reticle pod 8, which is then stored in high vacuum reticle library 53 in sequence to ensure absolute cleanliness of the inner box 83 and the reticle within.

Subsequently, when the lithography tool 6 is to perform exposure process under the control of the controller, another robot 5 in the lithography tool 6 carries the reticle out of the inner box 83 in the reticle library 53 and transports the inner box 83 to the optical system 73 for the exposure process to be performed. After the exposure process is completed, the robot 5 carries the reticle one by one back to the inner box 83 in the reticle library 53. The robot 4 then carries the inner box 83 out of the reticle library 53 and returns to the transportation chamber 55, as indicated by the direction shown by arrow No. 6 as manifested in FIG. 5. The controller then commands the outer box 81 to be loaded in the upper chamber 521 of the first inspection apparatus 52, and the upper chamber 521 is vacuum exhausted for the degree of vacuum to reach below 10⁻¹ torr; the controller then opens the inner side door of the upper chamber 521 for the inner box 83 to be placed in the outer box 81, as indicated by the direction shown by arrow No. 7 as manifested in FIG. 5. The controller closes the inner side door of the upper chamber 521. Then, the controller breaks the vacuum in the upper chamber 521 (i.e. releasing air) and thus the first side door (i.e. the outer side door) of the upper chamber 521 of the first inspection apparatus 52 opens for the EUV reticle pod 8 to be moved out and transported onto the carrier of EUV reticle pod, as indicated by the direction shown by arrow No. 8 as manifested in FIG. 5. The controller then closes the first side door (i.e. the outer side door) of the upper chamber 521 of the first inspection apparatus 52. The robot 4 then carries out another inner box 83 stored in the reticle library 53 and transports the inner box 83 to the optical system 73 for the exposure process to be performed. The aforementioned procedures are repeated till the exposure process terminates and all EUV reticle pods 8 are moved out of the carrier of EUV reticle pod to complete the exposure process.

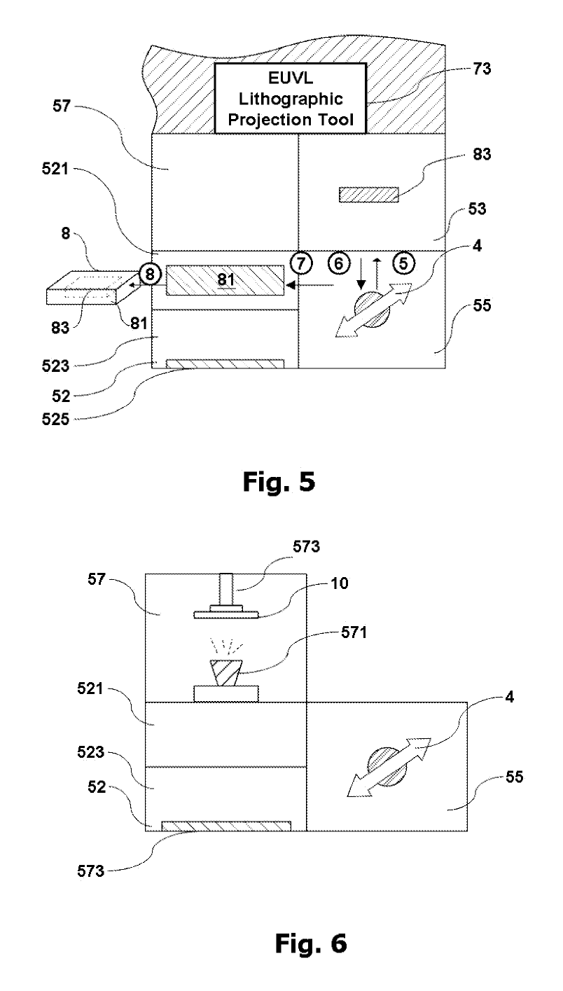

Moreover, in order to further ensure that the inner box 83 transported into the optical system 73 for exposure process is absolutely clean and to increase the production yield, the present invention further discloses another cleaning system, which is composed of a first inspection apparatus 52, a transportation chamber 55, a reticle conveyance robot 4 disposed in the transportation chamber 55, and a second inspection apparatus 56, as shown in FIG. 6, wherein the first inspection apparatus 52 of the present invention is further segregated into an upper chamber 521 and a lower chamber 523. Since the procedures of loading the EUV reticle pod 8 into the upper chamber 521 and carrying out the inner box 83 of the EUV reticle pod and then transporting it to the lower chamber 523 are the same as those in the previous embodiments, and more particularly, the cleaning procedure performed on the inner box 83 in the lower chamber 523 is also the same as that in the previous embodiments, therefore the procedures above are not repeatedly described in the following. The main characteristic of the present embodiment lies in that when the lithography tool 6 is to perform exposure process under the control of the controller, the robot 4 carries the reticle 10 out of the inner box 83 in the reticle library 53 and first transports the reticle onto the base 573 of the second inspection apparatus 57 and then gas filling is performed on the reticle 10 by the nozzle 571 on the second inspection apparatus 57 for at least once to prevent particles from adhering to the reticle, the gas filled being N2 or dry air. After gas filling is performed for at least once in the second inspection apparatus 57, the robot 5 then carries the reticle out of the second inspection apparatus 57 and transports it to the optical system 73 for the exposure process to be performed. What is to be emphasized here is that the second inspection apparatus 57 and corresponding cleaning procedure in the present embodiment can be selectively deployed.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A reticle cleaning method for lithography tool, wherein an inspection apparatus deployed in a lithography tool is used to perform cleaning procedure on reticle in an EUV reticle pod, said inspection apparatus being composed of an upper chamber and a lower chamber, said reticle cleaning method comprising:
transporting said EUV reticle pod to said upper chamber of said inspection apparatus, said EUV reticle pod comprising an outer box and an inner box and said reticle being stored in said inner box;
forming vacuum in said upper chamber;
transporting said inner box of said EUV reticle pod to said lower chamber of said inspection apparatus;
performing cleaning procedure on said reticle, first vacuum exhausting said lower chamber and then filling said EUV reticle pod with gas, wherein gas to be filled is an inert gas provided for filling said inner box to form a gas flow field in said inner box that brings away particles on said reticle;
transporting said inner box to a reticle library.

2. The reticle cleaning method according to claim 1, wherein the transportation of said inner box is performed by a robot.

3. The reticle cleaning method according to claim 1, wherein said inert gas is N2 or He.

4. The reticle cleaning method according to claim 1, wherein said cleaning procedure of said reticle further comprises repeatedly performing procedures of vacuum exhausting and gas filling multiple times.

5. A reticle cleaning method for lithography tool, wherein an inspection apparatus deployed in a lithography tool is used to perform cleaning procedure on reticle in an EUV reticle pod, said inspection apparatus being composed of an upper chamber and a lower chamber, said reticle cleaning method comprising:
transporting said EUV reticle pod to said upper chamber of said inspection apparatus, said EUV reticle pod comprising an outer box and an inner box and said reticle being stored in said inner box;
forming vacuum in said upper chamber;
transporting said inner box of said EUV reticle pod to said lower chamber of said inspection apparatus;
performing cleaning procedure on said reticle, first vacuum exhausting said lower chamber and then filling said EUV reticle pod with gas, wherein said gas filling procedure comprises: providing an ionized inert gas for being filled in said inner box, and providing an inert gas for being filled in said inner box after the filling of said ionized inert gas is completed for said ionized inert gas to form a gas flow field in said inner box that removes electric charges on said reticle and simultaneously for said inert gas to form another gas flow field in said inner box that brings away particles on said reticle;
transporting said inner box to a reticle library.

6. The reticle cleaning method according to claim 5, wherein the transportation of said inner box is performed by a robot.

7. The reticle cleaning method according to claim 5, wherein said inert gas is N2 or He.

8. The reticle cleaning method according to claim 5, wherein said cleaning procedure of said reticle further comprises repeatedly performing procedures of vacuum exhausting and gas filling multiple times.

9. A reticle cleaning method for lithography tool, wherein a cleaning system disposed in a lithography tool is used to perform cleaning procedure on reticle in an EUV reticle pod, said cleaning system being composed of a first inspection apparatus and a second inspection apparatus, and said first inspection apparatus being composed of an upper chamber and a lower chamber, said reticle cleaning method comprising:
transporting said EUV reticle pod to said upper chamber of said first inspection apparatus, said EUV reticle pod comprising an outer box and an inner box and said reticle being stored in said inner box;
forming vacuum in said upper chamber;
transporting said inner box of said EUV reticle pod to said lower chamber of said first inspection apparatus;
performing cleaning procedure on said reticle, first vacuum exhausting said lower chamber and then filling said EUV reticle pod with gas, wherein gas to be filled is an inert gas provided for filling said inner box to form a gas flow field in said inner box that brings away particles on said reticle;
transporting said inner box to a reticle library;
transporting said reticle to said second inspection apparatus, wherein said reticle is first carried out of said reticle library and then transported to said second inspection apparatus;
performing gas filling procedure for at least once, wherein said gas filling procedure is performed on said reticle in said second inspection apparatus for at least once; and
transporting said reticle to an optical system for exposure process to be performed.

10. The reticle cleaning method according to claim 9, wherein the transportation of said inner box is performed by a robot.

11. The reticle cleaning method according to claim 9, wherein said inert gas is N2 or He.

12. The reticle cleaning method according to claim 9, wherein said cleaning procedure of said reticle further comprises repeatedly performing procedures of vacuum exhausting and gas filling multiple times.

13. The reticle cleaning method according to claim 9, wherein in said cleaning procedure of said reticle, an ionized inert gas is further provided for being filled in said inner box.

14. The reticle cleaning method according to claim 9, wherein the gas filled in said second inspection apparatus is N2 or dry air.

15. A reticle cleaning system disposed in lithography tool that performs cleaning procedure on reticle in an EUV reticle pod as commanded by a controller in said lithography tool, said EUV reticle pod comprising an outer box and an inner box and said reticle being stored in said inner box, wherein said reticle cleaning system comprises:
an investigation apparatus, said inspection apparatus being composed of an upper chamber and a lower chamber isolated from each other, a base being disposed in said lower chamber and a vacuum exhausting valve and at least a gas valve being disposed on said base; and
a robot, disposed in a vacuum transportation chamber, transportation of said inner box in said EUV reticle pod being performed by said robot.

16. A reticle cleaning system disposed in lithography tool that performs cleaning procedure on reticle in an EUV reticle pod as commanded by a controller in said lithography tool, said EUV reticle pod comprising an outer box and an inner box and said reticle being stored in said inner box, wherein said reticle cleaning system comprises:
a first investigation apparatus, said first inspection apparatus being composed of an upper chamber and a lower chamber isolated from each other, a base being disposed in said lower chamber and a vacuum exhausting valve and at least a gas valve being disposed on said base;
a robot, disposed in a vacuum transportation chamber, transportation of said inner box in said EUV reticle pod being performed by said robot; and
a second investigation apparatus, said second investigation apparatus being disposed with a nozzle.
